(19) United States
(12) Patent Application Publication
(10) Pub. No.: US 2021/0370852 A1
(43) Pub. Date: Dec. 2, 2021

(54) Dent Preventer

(71) Applicant: Joyce Ann Nicholson, Baltimore, MD (US)

(72) Inventor: Joyce Ann Nicholson, Baltimore, MD (US)

(21) Appl. No.: 16/884,457

(22) Filed: May 27, 2020

(51) Int. Cl. B60R 13/04

(52) U.S. Cl. CPC B60R 13/043

(57) ABSTRACT

A dent preventer provides a barrier that extends from underneath the SUVs' and cars to prevent dents in the front and rear doors. The dent preventer is a hard black rubber barrier that slides out beyond the doors along the sides of the vehicle. It is activated once the vehicle is parked, ignition is turned off, doors locked, and the activation and the use of the automatic key switch.

### FIELD OF THE INVENTION

My present invention relates to a dent preventer designed to protect cars and SUVs', particularly, to protect the side of the doors from other parallel parked vehicles in commercial or residential areas.

### BACKGROUND OF THE INVENTION

Dent preventer have been presented in a variety of forms and in many cases have been and underrun protection intended for all vehicles. There have been numerous proposals for apparatus to protect a side portion of a vehicle from dents. For example, U.S. Pat. Nos. US 2005/0104390 A1, the underrun protection for vehicles has shift unit attachable to the vehicle including on one hand a first box, which is comprised of bottom wall and a border along the periphany.

Dent preventers may be modified to accommodate the need of the customer, for example, the proper design may eliminate dents in the side of doors as well as define its physical appearance.

The following patents also are relevant structure, dent preventer and the like:

U.S. Pat Nos. 2005/0104390 A1, US 2007/0273167 A1, U.S. Pat. Nos. 3,718,357, 4,217,715, 7,967,349, B2

Notwithstanding the extensive art in frame construction, dent preventer and the like; there remain a need for a dent preventer which can be beneficial to customers as well as deferring cost and harm to their vehicle doors and maintaining its professional appearance.

### OBJECT OF THE INVENTION

A primary benefit provided by the dent preventer include, but not limited to, granting vehicle owners a device to prevent dents in their doors.

Another object of this invention is to provide an improved dent preventer which protects the investment an owner has made in their vehicle. The dent preventer is discrete and deploys automatically when driver of the SUV's and cars use the automatic switch attached to car keys.

It has been that mistakes are often made with design of the previous dent preventers. With the system of the invention, potential and applications of an innovation consideration should always be given to cross-utilization and further modification of a new product.

### SUMMARY OF THE INVENTION

In assessing the future of the dent preventer, the primary benefit provided by the product include, but not limited to granting SUV and car owners a device to prevent dents in their doors.

Advantageously, the dent preventer protects the investment an owner has made in their vehicle. The dent preventer is also discrete and deploys automatically using the automatic switch attached to the keys.

In a market atmosphere where improvements to invaluable, common products are popular in the shelves, particularly when backed by an industry brand name, manufacturers of automotive accessories will profit from offering the dent preventer.

Given the design advantages of this product, its utility and convenience are immediately evident. Economical and practical, it should have no trouble tapping into this vast, lucrative market.

### BRIEF DESCRIPTION OF THE DRAWING

The above and other objects features and advantages will become more readily apparent from the following description, in reference being made to the accompanying drawing in which:

FIG. 1 is a diagrammatic perspective view of a dent preventer according to the invention:

FIG. 2 is an exploded view illustrating the principles of the dent preventer (slides from underneath the door):

FIG. 3 is a view of the door contact dent preventer:

FIG. 4 is a view of a hard rubber and: how the hard rubber slides from underneath the car when the ignition is turned off and automatic switch is used to lock the doors.

FIG. 5 is a view of how it folds under once the ignition starts or doors are unlocked using an automatic switch on the keys.

### SPECIFIC DESCRIPTION

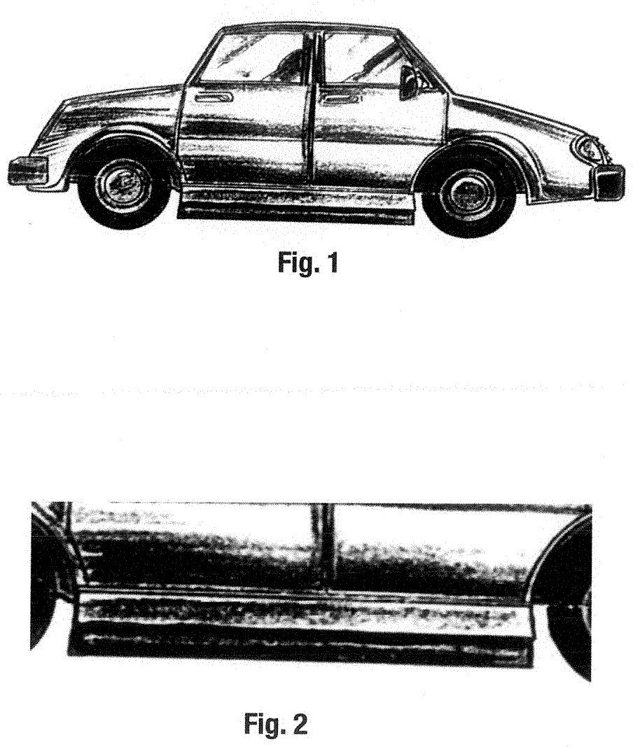

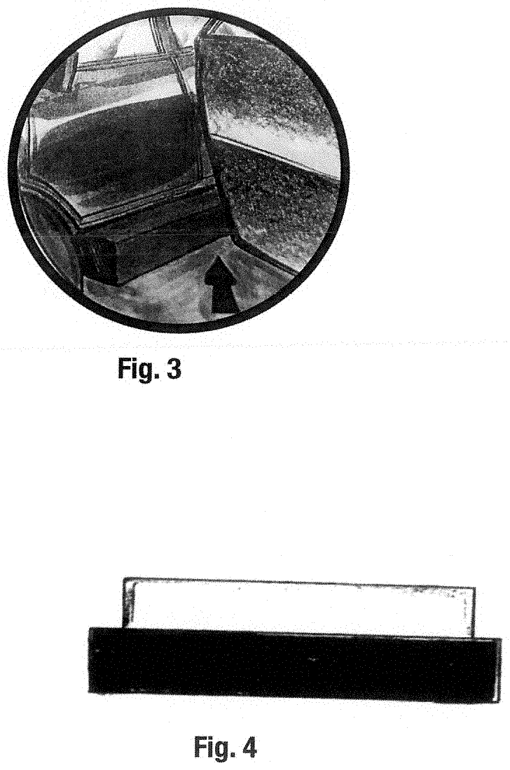

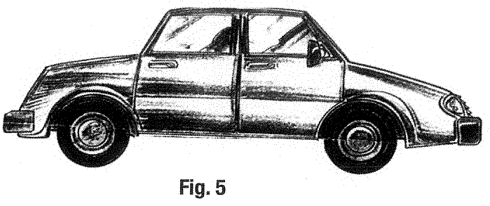

In FIG. 1 I have shown a car with barrier that extends from under a car or SUV whenever it's parked and the automatic switch is used to lock the doors. The barrier will prevent adjacently parked vehicles from opening their doors and denting or dinging a user's vehicle. In FIG. 2 I have shown a design of the dent preventer. It is three inches thick hard rubber that extends from underneath the car made part steel and the rubber absorbs the impact of a parallel parked car. In FIG. 3 I have shown how the dent preventer operates when it is paralleled parked and comes in contact with a SUV or car. It slides out six inches underneath the SUV or car when the ignition is turned off and the doors are locked and the automatic key switch is used to activate the dent preventer. FIG. 4: The diagram shows how it protects your car door from dents while you are paralleled parked. It is a hard black steel and rubber. FIG. 5 I have shown how the dent preventer folds underneath the car or SUV when driving or in motion.

The dent preventer can be used for SUVs' and cars. The design may be offered as an aftermarket kit or incorporated into existing vehicles designs. An important advantage of the dent preventer is to protect the investment an owner has made in their vehicle. It is discrete and deploys automatically. This product would also appeal to automobile manufacturers for inclusion in their own vehicle model. Given the design advantages of the product, its utility and convenience are immediate evidence. Economical and practical, it should have no trouble tapping into the vast, lucrative market.

What is claimed is:

1. A dent preventer for SUVs' and cars, comprising:
A dent preventer is formed with an elongated five inch thick silver steel sheeting and a hard black rubber that is housed underneath the SUV or car and extends six inches horizontally from underneath along each sides of the vehicle
A barrier that extends from underneath a car or SUV whenever it is parked, the ignition is turned off, and is activated using the automatic key switch.
The barrier will prevent adjacently parked or parallel parked vehicle from opening their doors and denting the doors of other parallel parked vehicles.
